(19) United States
(12) Patent Application Publication
(10) Pub. No.: US 2021/0236912 A1
(43) Pub. Date: Aug. 5, 2021

(54) GAME SYSTEM, GAME TOY, AND PROGRAM

(71) Applicant: BANDAI CO., LTD., Tokyo (JP)

(72) Inventors: Keiichi ENDO, Tokyo (JP); Risako HAYASHIDA, Tokyo (JP)

(73) Assignee: BANDAI CO., LTD., Tokyo (JP)

(21) Appl. No.: 17/148,394

(22) Filed: Jan. 13, 2021

(30) Foreign Application Priority Data
Jan. 31, 2020 (JP) 2020-015488

(51) Int. Cl. A63F 1/04; A63F 3/00

(52) U.S. Cl. CPC A63F 1/04; A63F 3/00643; A63F 3/00697

(57) ABSTRACT

Provided are a game system, a game toy, and a program enabling a player to play the game easily. The game system is a game system implementing a match game played by players. The game system includes, for each of the players: a game toy, and an information communication terminal. The match game progresses through communications between the information communication terminals of the players. The game toy includes: a game item provided with game element information, a play field on which the game item is able to be arranged, and an acquisition item that is configured to be capable of acquiring the game element information provided to the game item, and transmits the acquired game element information to the information communication terminal. The information communication terminal includes: a reception unit that receives an action instruction related to the match game, for the game item arranged on the play field related to a corresponding one of the players, a resolving unit that resolves an action based on the action instruction received by the reception unit, and a notification unit that issues a notification of an operation instruction for the game item arranged on the play field based on a result of the resolution by the resolving unit.

### CROSS REFERENCES TO RELATED APPLICATIONS

This application claims priority to Japanese Patent Application No. 2020-015488 filed in the Japan Patent Office on Jan. 31, 2020, the entire contents of which are incorporated herein by reference.

### BACKGROUND

### Field of the Invention

The present invention relates to a game system, a game toy, and a program, and particularly relates to a game that progresses with game items arranged on a board.

### Description of the Related Art

There are types of games that progresses with tangible game cards arranged on a field or the like, such as a trading card game (JP-A-2006-247178).

### SUMMARY

A match type card game as described in JP-A-2006-247178 requires a player to resolve the exertion of an effect displayed on a fighting card used in the game. More specifically, when two players are playing the match type card game and one of them declares exertion of an effect related to any of his or her fighting cards, for example, each player has to check whether the exertion condition of the effect is satisfied, confirmation of the result based on a comparison in a numerical value between the card and a fighting card of the other player which is the target of the effect, and the like, to make the game progress.

Players may feel such manual resolution processing cumbersome. Furthermore, the match type card game has been plagued by the fact that such a rule and regulation need to be understood to play the game, making new players hesitate to play it.

An object of the present invention is to provide a game system, a game toy, and a program enabling a player to play the game easily.

A game system according to the present invention is a game system implementing a match game played by players. The game system includes, for each of the players: a game toy, and an information communication terminal. The match game progresses through communications between the information communication terminals of the players. The game toy includes: a game item provided with game element information, a play field on which the game item is able to be arranged, and an acquisition item that is configured to be capable of acquiring the game element information provided to the game item, and transmits the acquired game element information to the information communication terminal. The information communication terminal includes: a reception unit that receives an action instruction related to the match game, for the game item arranged on the play field related to a corresponding one of the players, a resolving unit that resolves an action based on the action instruction received by the reception unit, and a notification unit that issues a notification of an operation instruction for the game item arranged on the play field based on a result of the resolution by the resolving unit.

With such a configuration, the present invention enables a player to easily play the game.

### BRIEF DESCRIPTION OF THE DRAWINGS

FIG. 1 is a diagram illustrating an example of a configuration of a game system according to an embodiment and a modification of the present invention;

FIG. 2 is a diagram illustrating an example of an outer appearance configuration of a play field 130 according to an embodiment and a modification of the present invention;

FIG. 3 is a diagram illustrating an example of an outer appearance configuration of a figure 140 according to an embodiment and a modification of the present invention;

FIG. 4 s a block diagram illustrating a functional configuration of a smartphone 200 according to an embodiment and a modification of the present invention;

FIG. 5 is a diagram illustrating an example of an outer appearance configuration of a character card 110 according to an embodiment and a modification of the present invention;

FIG. 6 is a diagram for explaining a stage card 120 according to an embodiment and a modification of the present invention;

FIG. 7 is a flowchart illustrating game processing executed on a smartphone 200 according to an embodiment and a modification of the present invention; and

FIG. 8 is a diagram illustrating an example of a data configuration of various information used in a game system according to an embodiment and a modification of the present invention.

### DETAILED DESCRIPTION

### Embodiments

Hereinafter embodiments are described in detail with reference to the accompanying drawings. It should be noted that the embodiments described below are not intended to limit the invention defined in the appended claims, and not all the combinations of features described in the embodiments are essential for the invention. Two or more features among a plurality of features described in the embodiments may be combined as appropriate. The same or similar configurations are denoted by the same reference numerals, and redundant description thereof will be omitted.

An embodiment described below serves as an example of a game system, and explains an example in which the present invention is applied to a game toy including a group of cards and a play field on which these cards are arranged, and a smartphone that progresses a match game by executing an application related to the match game providing a play experience with the game toy and by communicating information with another terminal executing the application in a similar manner. The present invention is also applicable to any devices that can progress a match game by acquiring information on an arrangement status of each of a plurality of players for a game toy that uses game items arranged in any field for each player.

### Configuration of Game System

A game system of the present embodiment implementing a match game between players will be described below with reference to the drawings.

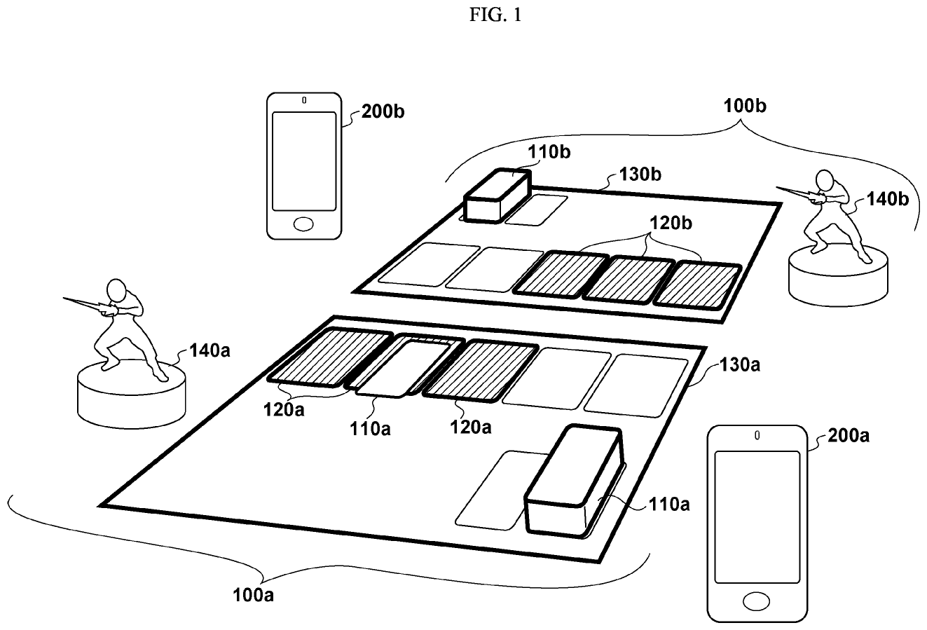

As illustrated in FIG. 1, a game system of the present embodiment includes game toys 100 (a and b) and smartphones 200 (a and b) for respective players playing a match game. As will be described in detail below, the match game is configured to be playable by a plurality of players face to face, and progresses with the smartphones 200 each acquiring information about a state of the game toy 100 of a corresponding player, and with the information communicated between the smartphones 200. Various calculations and result confirmations (resolution) for making the match game progress is executed by the smartphones 200, unlike in the case of conventional TCGs. Thus, the players can play the game without fully understanding various rules for resolving his or her actions, and thus can play the game while concentrating on his or her tactics.

For the sake of simplicity, in the present embodiment, the match game is described as a game to be played with two players face to face deploying their game toys 100 (a and b), and operating the smartphone 200 (a and b) and various game items. However, the present invention is not limited to this mode. The match game is not limited to two player games, and may be played by three or more players. Furthermore, the players do not necessarily be face to face to play the game. For example, an opponent player may be at a remote location. In such a case, based on information transmitted from the smartphone 200 of the opponent player, a screen displaying a state of the player's play field is presented. Thus, the players can play the game under a condition that is the same as that in a case where they are face to face.

### Configuration of Game Toy

First of all, a configuration of the game toy (which may be any one of a and b in the description below) will be described. In the present embodiment, the game toy 100 used by each player includes: a predetermined number of character cards 110 that are a first game item according to the present invention; a stage card 120, serving as a second game item according to the present invention, the number of which is determined in accordance with the number of players; a play field 130 on which these items can be arranged; and a figure 140 serving as an acquisition item according to the present invention. The character card 110, the stage card 120, the play field 130, and the figure 140 are described as being provided to each of the players. However, for example, some of these items, such as the play field 130 or the figure 140, may be sharable by a plurality of players playing the game system.

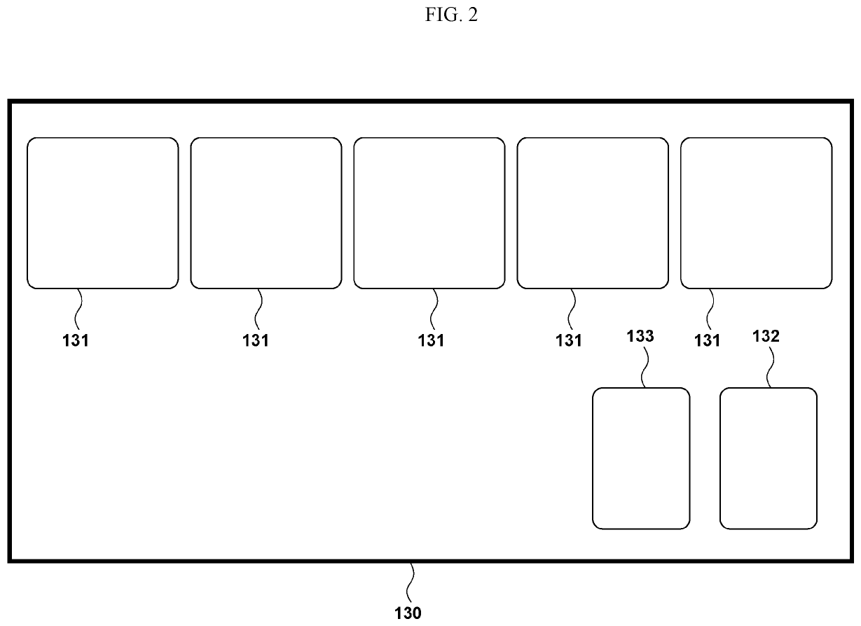

As illustrated in FIG. 2, the play field 130 is configured to be in a sheet form for example, and is used in a match game for placing the character card 110 and the stage card 120 thereon. The play field 130 is provided with an arrangement portion 131, a deck portion 132, and a discard portion 133 that are visible to indicate where the player should place the character card 110 and the stage card 120. More specifically, the deck portion 132 indicates a position where the character card 110 is placed to be a deck in the match game. The arrangement portion 131 indicates the positions where the stage card 120 to be used, and the character card 110 that can make an action in the match game are to be placed. The discard portion 133 indicates a position where a character card 110 that can no longer make any actions is placed. The match game of the present embodiment does not involve the concept of “hand”, and a character card 110 drawn from the deck is directly placed on the stage card 120 in the arrangement portion 131, to the card on the board, as will be described later.

The character card 110 and the stage card 120 are associated with any of game elements related to the match game, and are provided with information identifying the game elements. The cards may be provided with the information with a storage medium such as an IC chip storing the information embedded in the cards. Although the present embodiment is described assuming the information is provided to the character card 110 and the stage card 120 with the storage medium embedded in the cards, but the embodiment of the present invention is not limited to this. The information may be provided to the card with a code to which the information is converted or a code associated with the information provided on the card by printing or the like for example.

The information provided differs between the character card 110 and the stage card 120. Specifically, the character card 110 is provided with first game element information according to the present invention which is information (character ID for example) enabling a character, in the match game, associated with the card to be identified. The stage card 120 is provided with second game element information according to the present invention which is information (stage ID for example) enabling a stage, in the match game, associated with the card to be identified. The information provided to the character card 110 and the information provided to the stage card 120 are for identifying different types of game elements in the match game, as can be understood in more detail description on these types of information given below. Thus, the character card 110 and the stage card 120 are configured to be identifiable not only with their outer appearance but also with the information provided.

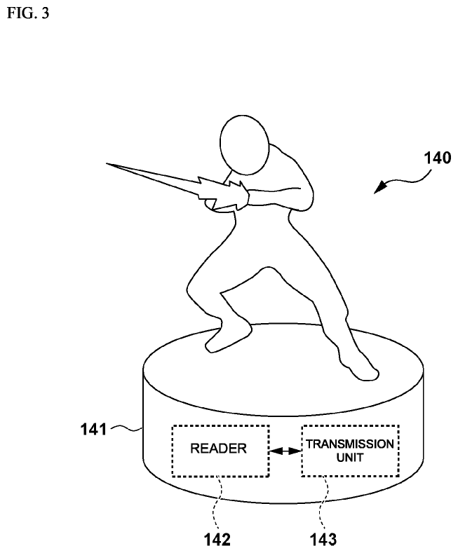

According to the game toy of the present embodiment, the information provided to the card is read by a figure 140. The figure 140 is configured to have an outer appearance of a character appearing in the match game (meaning that there is a character card representing such a character) to make the match game more entertaining. As illustrated in FIG. 3, the FIG. 140 has a reader 142 for acquiring information embedded in a pedestal portion 141 for example. The reader 142 acquires the information (at least one of the card ID and the stage ID) provided to a card, when the card approaches the bottom surface of the pedestal portion 141. The reader 142 is configured to be capable of simultaneously acquiring information pieces of a plurality of respective cards in a stacked state. A transmission unit 143 of the figure 140 transmits the information, acquired by the reader 142, to the smartphone 200.

The figure 140 of the present embodiment is described as a member with which the information is acquired in response to the card approaching the reader 142, but how the information is acquired by the reader 142 according to an embodiment of the present invention is not limited to this. The information may be acquired in response to the card coming into contact with the reader 142, or an attempt to acquire the information may be made in response to a predetermined operation input.

The game toy of the present embodiment is described assuming that the first game item and the second game item are described to be configured to be card members to be stackable on the play field 130, and that the acquisition item is a three-dimensional modeled object having the pedestal portion 141 with the bottom surface configured to be flat so as to be placeable on the plurality of game items stacked. However, an embodiment of the present invention is not limited to this. The first game item, the second game item, and the acquisition item may be configured in any appropriate mode.

### Functional Configuration of Smartphone

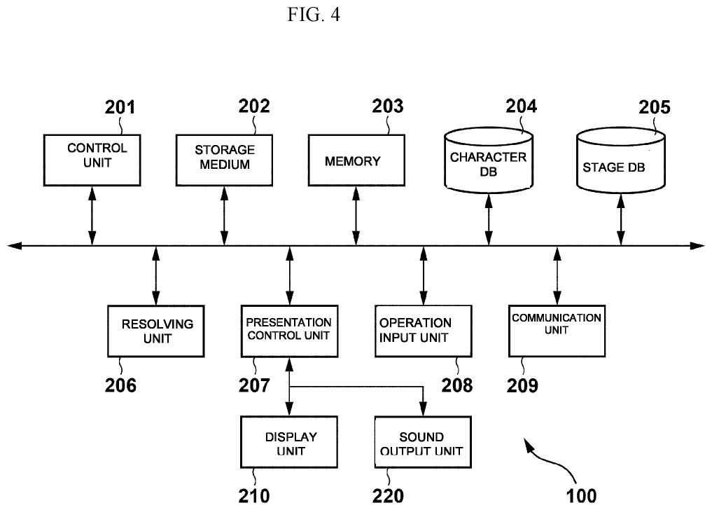

FIG. 4 is a block diagram illustrating a functional configuration of a smartphone 200 according to an embodiment of the present invention.

The control unit 201 is, for example, an information processing processor and controls the operations of blocks of the smartphone 200. Specifically, the control unit 201 reads an operation program for the blocks and a program related to a game application that are stored in a storage medium 202, and loads the program onto a memory 203 and executes the program to control the operations of the blocks.

The storage medium 202 is, for example, a storage device such as a non-volatile memory and an HDD that can permanently hold data. The storage medium 202 stores, in addition to the operation program for the blocks and the game program related to a match-game related application (match application), information such as a parameter required for the operations of the blocks and various types of graphic data used in the match game executed by the smartphone 200. The memory 203 is a storage device such as a volatile memory used for temporarily storing data for example. The memory 203 is not only used as a region onto which the operation program for the blocks and the game program for the match application are loaded, but is also used a storage region for temporarily storing data or the like output during the operation of the blocks.

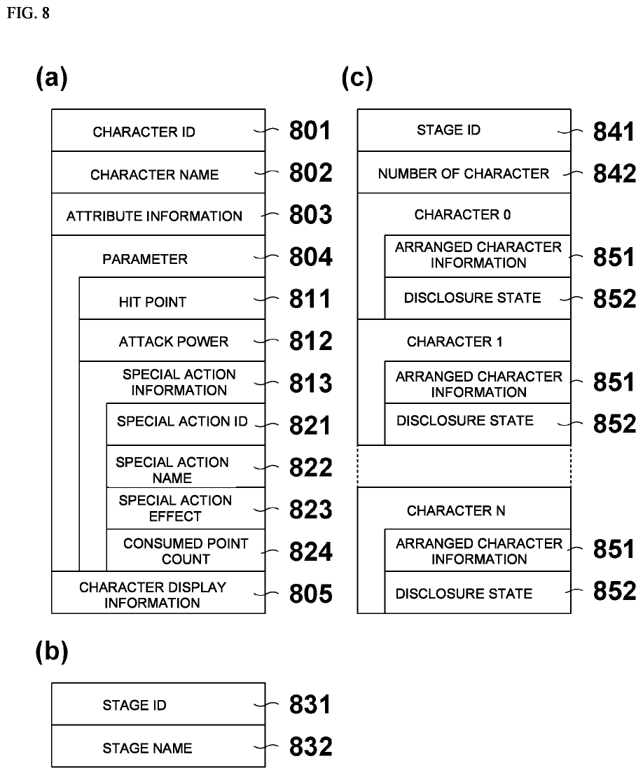

A character DB 204 is a database managing character information for each character associated with the character card 110 provided to be usable in the match game. As illustrated in FIG. 8(a) for example, the character information managed for one character may include, in association with a character ID 801 uniquely identifying the character: a character name 802 of the character; attribute information 803 indicating an attribute determined for the character; a parameter 804 identifying the characteristics of the character referred to for controlling the progress of the game; and character display information 805 indicating image and model data and the like to be used for displaying the character or the character card 110 on the game screen.

This attribute information 803 is information used for determining whether an attack action, made between characters, succeeds. Any one of three types of attributes in what is known as a trilemma state is allocated to one character card 110. The parameter 804 includes: a hit point 811; an attack power 812; and special action information 813 describing various types of information on a special action uniquely provided to the character separately from the normal attack, which enable the control for making the match game progress. The special action information 813 includes, for each special action; a special action ID 821 uniquely identifying the special action; a special action name 822 that is a name of the special action; a special action effect 823 describing an effect on the match game occurring in response to the special action; and a consumed point count 824 indicating how much action points are required to be consumed to make the special action.

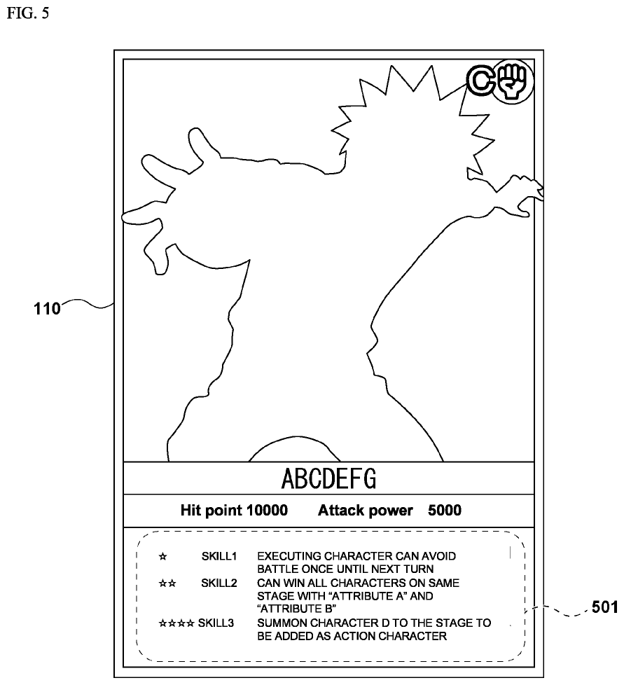

The special action one character can make is clearly described in a special action region 501 in the outer appearance of the corresponding character card 110 as illustrated in FIG. 5, so that when the character card 110 is placed on the play field 130 face up, all the players in the match game can recognize the action.

For the sake of simplicity of explanation, in the present embodiment, a mode is described where one character is provided with only one type of character card 110, and which of the character card 110 is used is identifiable with the character ID. However, modes of the present invention are not limited to this. Specifically, the present invention can be applied to a mode in which each character is provided with a plurality of types of character cards 110 of different parameters. In such a case, for example, the character card 110 may be provided with a card ID uniquely identifying the card, and the corresponding character information may be configured to be identifiable with the card ID.

A stage DB 205 is a database for managing the stage information for each of the stage cards 120 provided to be usable in the match game. As illustrated in FIG. 8(b), the stage information managed for one stage card 120 may be configured to include, in association with a stage ID 831 uniquely identifying the stage card 120, a stage name 832 of the stage associated with the stage card 120.

The resolving unit 206 resolves an action that has occurred in relation to the character card 110 arranged in the play field 130 while the match game is being played. As will be described in detail later, when an operation input related to determination of an action to be made is input from the smartphone 200 of the player in his or her action turn, the resolving unit 206 resolves the action based on information on the arrangement status of the character card 110 of the opponent player on the play field 130 or information on the arrangement status of the character card 110 of the own player on the play field 130, and information on the effect exerted. When the action is normal attack, the resolving unit 206 reduces a hit point value of the character card related to the opponent player who is an attacking target, based on the attack power 812 on the character card making the action.

The presentation control unit 207 is in charge of controlling presentation of various types of information to the player using the smartphone 200. The smartphone 200 of the present embodiment is described to have a unit for presenting various types of information to the player, including: a display unit 210 that displays a screen (such as a game screen, or other OS menu screens) and a sound output unit 220 that output sound. However, the information presentation unit is not limited to these, meaning that it is a matter of course that these components can be replaced or other components can be added.

The presentation control unit 207 includes a rendering device such as a graphic chip, and executes predetermined rendering processing for generating a game screen displayed by the display unit 210. Specifically, while the match application is being executed, the presentation control unit 207 renders and generates various game screens related to the match game based on information on the arrangement status of the cards of the own player in the play field 130, information on the arrangement status of the cards of the other player in the play field 130 received from the smartphone 200 of the other player in the match game, information on a result of the resolution by the resolving unit 206, and other operation inputs. The game screen thus generated is output to and displayed on the display unit 210 provided to the smartphone 200 to be presented to the player.

The display unit 210 is, for example, a display device such as an LCD of the smartphone 200. In the present embodiment, the display unit 210 is incorporated in and thus integrated with the smartphone 200. However, modes of the present invention are not limited to this. For example, the display device may be provided separately from the smartphone 200, and may be in detachable wired or wireless connection with the smartphone 200, for example.

The presentation control unit 207 includes, for example, a circuit such as a sound chip or an amplifier that outputs/amplifies a sound signal, and executes predetermined processing for generating a sound to be output from the sound output unit 220. Specifically, based on sound data recorded in advance in the storage medium 202, the presentation control unit 207 determines, for example, sound data pieces to be simultaneously output, converts the data into an electric sound signal (D/A conversion), and outputs the result to the sound output unit 220, whereby the sound is output. The sound output unit 220 may be a predetermined speaker and the like, and outputs a soundwave based on the input sound signal.

The operation input unit 208 is a user interface, such as a touch panel or a button, of the smartphone 200. Upon detecting the operation input made by the player, the operation input unit 208 outputs a control signal corresponding to the operation input to the control unit 201.

The communication unit 209 is a communication interface of the smartphone 200 for communicating with other devices. The communication unit 209 is connected to external devices over a network or directly, and exchange data with the external devices using a predetermined wired or wireless communication scheme. A program for the match application, data required for rendering, and the like may be configured to be receivable from the external devices via the communication unit 209.

### Overview of Match Game

Next, an overview of the match game offering a game experience according to the game system of the present embodiment will be described. The following description will be given with be the character card 110 and the stage card 120 arranged in the play field 130 simply referred to as a character and a stage for the sake of easier understanding of the invention. It should be noted that these are general terms used in the match application and they naturally indicate the corresponding cards.

The match game described as an example in the present embodiment is assumed to be a game of collecting “treasures” placed in any of the stages in the play field 130. Information indicating which stage has which treasure is determined by the match application when the match game stars, and is shared between the smartphones 200 of the participating players without being disclosed to the players. Note that the number of treasures hidden in a single stage is not limited to one. The treasure hidden in a stage is collected by a character placed in the stage performing a search action. The treasure that has been collected by a character can be seized by another character who has defeated the character by making an attack action.

The match game ends when any of the following condition is satisfied: (1) any of the player collects all the treasures, (2) all the treasures hidden in the play field 130 have been found, and (3) all the character cards 110 of any of the character have been discarded. In the case (1) the player who has collected all the treasure is the winner of the match game. In the cases (2) and (3), the winner of the match game is the player who has the most treasures in the end.

### Preparation Before the Game

Before the match game starts, each player shuffles the character cards 110 he or she uses, and stack the cards on the deck portion 132 on the play field 130 facing down. Both players place the stage card 120 corresponding to the common stage determined to be used in the match game by the match application for example, facing up on the arrangement portion 131 of their play fields 130. The stage cards 120 to be placed on the play field 130 correspond to different stages. The number of such cards may be the number of player in the match game+1 (three in a case of a two player game). The type of the stage card 120 placed on the play field 130 is determined by the match application of one of the players for example, and both players may be notified of the placement of the common stage card 120.

The match applications start on the smartphones 200 used by the players, with each of the smartphone registered as a match opponent's user terminal by the other. The match application enters a matching standby state when an operation input for starting the match game is made, to search a wireless communication range for the smartphone 200 similarly having the match application started and entered the matching standby state. When such a terminal is detected, a predetermined confirmation operation is performed, and then the smartphone 200 is registered as the match opponent's user terminal. In the present embodiment, the two players in the match game are face to face, so the match game played with the two smartphones 200 exchanging information through ad-hoc communications will be described. However, the communication scheme between the two smartphones 200 is not limited to this, and another communication scheme may be employed. For example, the communication may be performed over a predetermined network. In particular, for a match game played by players at remote locations, the devices may perform communications to exchange information via any suitable number of serves on the network.

### Game Progress

Next, how the match game of the present embodiment progresses will be described in detail.

The match game adopts turns, meaning that the game progresses with players taking action turns (turns) to be capable of accepting an action instruction. Which of the players gets the first turn may be randomly determined by the match application for example.

The player in his or her action turn can draw one card from the deck of the character cards 110 stacked on the deck portion 132. The player checks the card, and places it facing down on any of the stage cards 120 on the play field 130. Thus, the character associated with the card can be in a state of being capable of making actions in the stage. Instead of drawing a card from the deck, the player can move the character card 110 that has already been placed on the stage card 120, onto another stage card 120. The number of character cards 110 that can be placed on one stage card 120 is limited (three cards or the like). Thus, the player can place a plurality of character cards 110 on the stage card 120 corresponding to one arrangement portion 131.

When the arrangement status of the character cards 110 on the play field 130 changes due to the placement of the card drawn or a change in the arrangement, the player places the figure 140 on the group of cards arranged in the arrangement portion 131, so that the match information can recognize the information indicating which character card 110 is placed on which stage card 120. More specifically, the reader 142 of the figure 140 acquires the information provided to the group of cards in response to the placement of the figure 140, and the information (arrangement information) is transmitted to the smartphone 200 of the player via the reader 142. Thus, the control unit 201 can recognize the arrangement status of the arrangement portion 131.

The arrangement status of the group of cards on the play field 130 of the player who is in his or her action turn is included in the game screen of the match application to be presented on the display unit 210 of the smartphone 200 used by the player. At this point, the character card 110 in real space that has been drawn and placed during the action turn is placed face down on the arrangement portion 131, so as not to be disclosed to the opponent player. Thus, the information indicating which character card 110 has been placed is shared between the smartphone 200 but is presented only on the smartphone 200 used by the player in his or her action turn. All things considered the match game progresses with the content of the character card 110 newly drawn from the deck being recognized by the player in his or her action turn only, without being known to the opponent player.

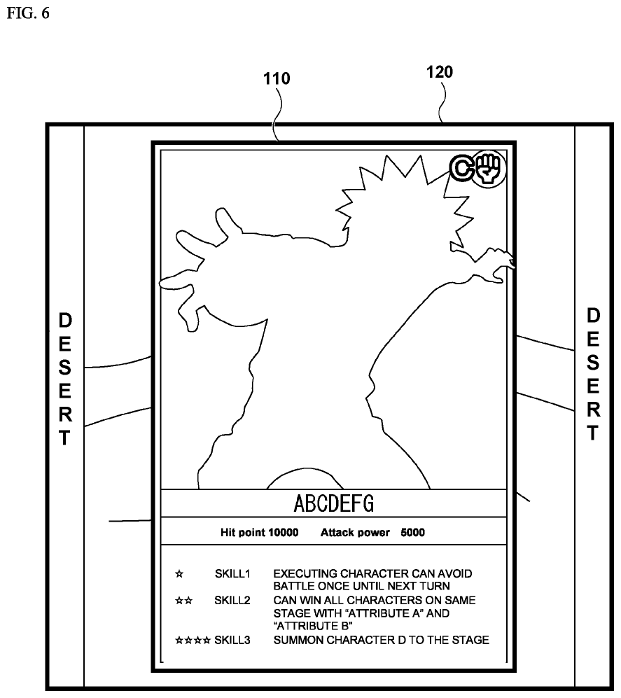

For example, as illustrated in FIG. 6, the character cards 110 and the stage cards 120 are different from each other in size, so that the player can easily recognize which stage a character is on. More specifically, the sizes of the cards are set so that at least a part of the stage card 120 is visible while the character card 110 is placed over the stage card 120. In the present embodiment, a configuration in which the stage card 120 is visible after having the character card 110 placed thereon due to the difference between the character card 110 and the stage card 120 in size. However, modes of the present invention are not limited to this, and the character card 110 and the stage card 120 may have the same size (of rectangle shape) as if there is a rule stipulating that the character card 110 and the stage card 120 have to be arranged in different orientations (for example, vertical and sideways).

In each action turn, an “action point” that can be accumulated over the action turns are given to the player. The action point is a point consumed when the player in his or her action turn makes an action. To make the game more entertaining, for example, the amount of points given increases each time the action turn comes, so that the variety of the action that can be made increases. In conventional TCGs, the amount of action point given or accumulated is indicated by the number of special cards or stones arranged on the play field 130, meaning that the player has had to performing operations such as counting them or removing them. On the other hand, according to the game system of the present embodiment, the match application manages these to be recognizable on the display unit 210. Thus, no special operation is required for enabling the player to easily recognize on the game screen, how much action points are accumulated by each player and whether he or she has an enough points to make the desired action.

In the match game of the present embodiment, the action that can be made by a character of each player in his or her action turn is acceptably through an instruction operation from the player in his or her action turn, and may include the following actions for example.

### (1) Search Action (Consumed Point: 1)

When there is a treasure yet to be collected on a stage with a character, the character can make this action to acquire the treasure. The opponent player is notified of a stage in which the search action has been made, but only the player is notified of a result of the search action.

### (2) Scouting Action (Consumed Point: 1)

The character can make this action to reveal a character of the opponent player who is on the same stage (the action target stage) as the character. Specifically, when the opponent player has placed the character card 110 face down on the action target stage, the character card 110 can be flipped to face up.

### (3) Attack Action (Consumed Point: 1)

When a character is on a state on which a character of the opponent player is also arranged, the character (attack character) can make this attack action related to any of the attributes in the trilemma relationship on the character of the opponent player. The attribute of this attack to be made is freely selectable by the player on his or her smartphone 200, regardless of the attribute of the attack character. Whether the attack is successful is determined based on whether the attribute of the attack selected for the attack character overwhelms the attribute set to each attacked character.

When the attack is successful (win), the hit points corresponding to the attack power 812 of the attack character can be subtracted from the remaining hit points of the attacked character. Which of the characters is the attacked character can be revealed without revealing the attacked character. In this case, when the remaining hit point of the attacked character drops to or below 0, the character card 110 corresponding to the attacked character can be moved to the discard portion 133 of the opponent player. When the attacked character the hit points of which drop to or below 0 has a treasure, the attack character can acquire the treasure.

In a case of a draw (standoff), the remaining hit point cannot be changed, but which of the characters is the attacked character can be revealed without revealing the attacked character.

When the attack fails (lose), the hit points corresponding to the attack power 812 of the attacked character is subtracted from the remaining hit points of the attack character. In other words, the attack character is counterattacked by the attacked character. Furthermore, the attach character is revealed without revealing the attacked character. When the remaining hit point of the attack character drops to or below 0, the character card 110 corresponding to the attack character moves to the discard portion 133 of the player in his or her action turn. When the attack character the hit points of which drop to or below 0 has a treasure, the treasure is again hidden in the stage to be the target of acquisition through the search action.

### (4) Special Action (Consumed Point: Value Set for Each Action)

A special action set for a character that can make the action can be made by consuming a unique action point set to the special action (causing the character to make the special action). Examples of the special action may include: an action that immediately takes effect such as drawing the character card 110 again, or putting a character of the opponent character on the same state as the character making the special action in an action disabled state; and an action that takes effect against an action made by the opponent player until the next turn of the player, such as nullifying the search action made by the opponent player, or making a counterattack, regardless of the attribute, against the attack action made by the opponent player. The opponent player is notified of the fact that the special action has been made, but not the content or the effect of the action.

These actions are at least presented to the player in his or her action turn through the game screen on the smartphone 200 of the player. A selection operation for these actions can be accepted when the action points accumulated and the arrangement statuses of the cards of both players on the play field 130 satisfy a condition.

The resolving unit 206 resolves the action made, and a change in how the cards of any of the players are arranged on the play field 130 (a change in the orientation and/or the orientation of the character cards 110) and a change in parameters, as a result of the resolution is presented by the presentation control unit 207 of the player. For example, when the character card 110 of the opponent player placed on the play field 130 is determined to be changed from face down to face up as a result of the resolving the action, the sound indicating the such an operation instruction issued may be emitted from the sound output unit 220 of the smartphone 200 of the opponent player. For example, when the remaining hit points of the character of the opponent player is reduced as a result of resolving the action, the value of the remaining hit point after the reduction is not presented on the game screen of the smartphone 200 of the player in his or her action turn, but is presented on the game screen of the smartphone 200 of the opponent player.

Thus, the action that can be made in the match game of the present embodiment includes those that can be performed without disclosing the arrangement status of the play field 130 to the opponent player so that there will be more guessing going on between the players, whereby the game can be more entertaining.

### Game Processing

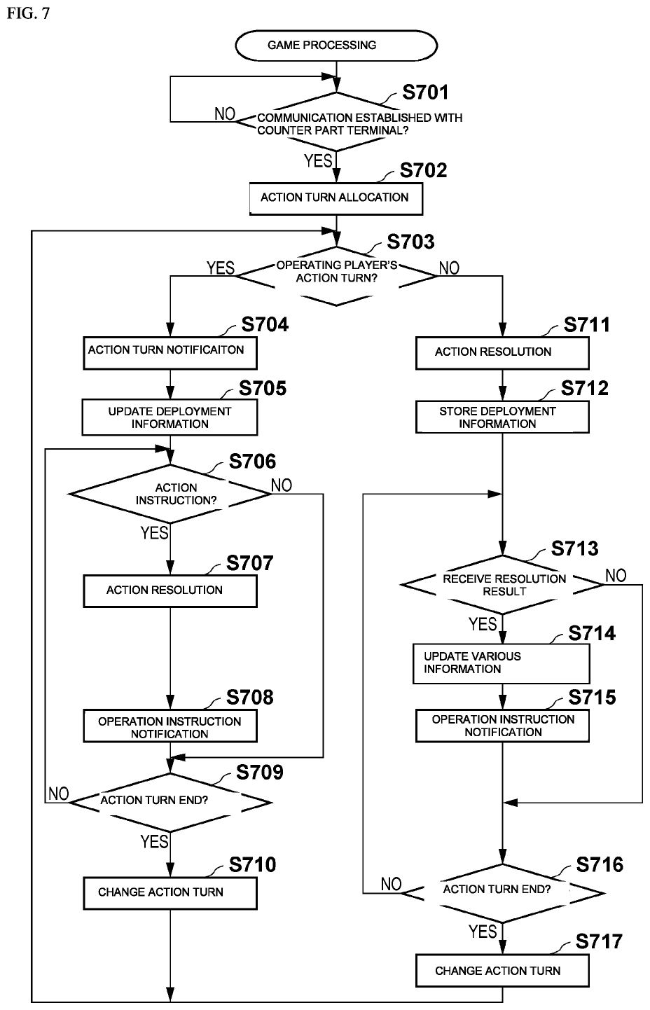

Game processing executed on the smartphone 200 for the match game of the present embodiment with the configuration described above will be described in detail with reference to a flowchart in FIG. 7. The processing corresponding to the flowchart can be implemented when the control unit 201 reads the corresponding processing program stored in the storage medium 202, load the program onto the memory 203, and executes the program.

For example, the game processing is described to be started when the operation input for starting the match game is made on the match application that has been started on the smartphone 200. The game screen presented on the display unit 210 of the smartphone 200 is updated by the presentation control unit 207 at least at a timing when the information required for the screen changes, to present the information reflecting the progress of the match game. The detail description of the display control processing will be omitted below unless required.

In S701, the control unit 201 determines whether connection with the smartphone 200 of the opponent player to be an opponent in the match game is established. As described above, in game system of the present embodiment, the smartphones 200 used by the players in the game need to be communicably connected to each other as a preparation before the match game can be started. Thus, the control unit 201 transitions to the matching standby state in response to an operation input for starting the match game, and then detects the smartphone 200 that is also in the matching standby state. Then, the determination in this step is made based on whether the communication unit 209 has established communicative connection with the smartphone 200 in response to an operation input for determining the smartphone 200 as the used terminal of the opponent. When the control unit 201 determines that the connection with the smartphone 200 of the opponent player has been established, the processing proceeds to S702. When the communication is determined to have not been established yet, the processing in this step is repeated.

When the operation input for completing the preparation for the game is made on both smartphones 200 involved in the match game, in S702, the control unit 201 determines which of the players will be allocated with the first action turn. Determination on the allocation of the first action turn may be made, for example, through negotiation between the control units 201 of both smartphone 200 or may be led by one of the control units 201. The information as a result of allocation of the action turn is shared between both smartphones 200.

In S703, the control unit 201 determines whether it is the operating player's action turn. When the control unit 201 determines that it is the operating player's action turn, the processing proceeds to S704. When it is not the operating player's action turn, that is, when it is determined to be the opponent player's turn, the processing proceeds to S711.

In S704 the presentation control unit 207 issues a notification indicating that it is the operating player's turn under the control performed by the control unit 201. The notification may be issued by the display unit 210 presenting the corresponding UI, by the sound output unit 220 outputting the corresponding sound, or a combination of these. The control unit 201 gives the action point in an amount corresponding to the current action turn.

In S705, the control unit 201 updates the information on the character that corresponds to the operating player and is arranged on each stage on the match application based on a change in the arrangement status of the operating player on the play field 130 (deployment information on the operating player). More specifically, the control unit 201 receives content of the operation performed by the operating player currently in his or her action turn (drawing a new character card 110 on the arrangement portion 131 or moving the already arranged character card 110 to a different arrangement portion 131) from the figure 140 placed on the card on the relevant arrangement portion 131, as the arrangement information, after such an operation has been performed. Based on the arrangement information, the control unit 201 acquires the character information corresponding to the character from the character DB 204, and updates the deployment information on the operating player.

For example, as illustrated in FIG. 8(c), the deployment information on the operating player includes: for each stage corresponding to the stage card 120 arranged on the play field 130, the number of characters 842 arranged on the stage in association with the stage ID 841; and for each character arranged, arranged character information 851 that is similar to the character information and a disclosure state 852 of the character (for example. logical information indicating whether the character is disclosed to the opponent player).

The arranged character information 851 includes information on a hit point of the character as in the character information, but this hit point indicates the “remaining hit point” as described above which may change as the match game progresses. Thus, when the character card 110 is arranged, an initial value of the hit point 811 in the relevant character information is stored as the hit point in the arranged character information 851. Then, when the character is attacked as the match game progresses, the hit point is updated to be a value smaller than the initial value.

The control unit 201 transmits the updated deployment information to the communication unit 209, to make the communication unit 209 transmit the information to the smartphone 200 of the opponent. As a result of the transmission, the information on the arrangement status of the operating player on the play field 130 is shared with the smartphone 200 of the opponent. This sharing is not for making the operating player and the opponent player recognize the common information via their smartphones 200. Rather, it is for sharing the information required for resolving actions in the match game, so that resolving unit 206 in both terminals can provide the same result.

In S706, the control unit 201 determines whether an operation input related to the action instruction related to the current action turn has been made. As described above, there are a plurality of types of actions that can be instructed by the operating player in his action turn. The action point required to be consumed is set for each of the actions. Thus, the control unit 201 controls the presentation control unit 207 to present the GUI that can accept an operation input for an action instruction only for the action that can be made with the action points currently possessed by the operating player. The GUI accepting the operation input for the action instruction may include: one accepting designation of a character that makes an action; one accepting selection of an action (search action, scouting action, attack action, or special action) made by the designated character; one accepting selection of an attribute of attack when the attack action is selected; and one accepting the action target character or a stage. When the control unit 201 determines that the operation input for the action instruction is made, the processing proceeds to S707. Otherwise, the processing proceeds to S709.

In S707, the resolving unit 206 resolves the action corresponding to the action instruction for which the operation input has been made, under the control by the control unit 201. The action is resolved based on the deployment information on the operating player and the deployment information on the opponent player received from the smartphone 200 of the opponent. In this process, the resolving unit 206 further uses information, of the deployment information on the opponent player, not included in the game screen on the smartphone 200 of the operating player. The resolving unit 206 updates, for example, required information such as the deployment information on any of the players, information on acquisition of a treasure, or information of the accumulated action points, in accordance with the resolution of the action. When a result of the resolution is obtained, the control unit 201 transmits the information on the resolution result to the communication unit 209 to transmit the information to the smartphone 200 of the opponent, so that the information is shared. The information thus transmitted as the information on the resolution result may be information indicating a difference as a result of a change in the information updated by the resolving unit 206 in this step.

In S708, the presentation control unit 207 performs, when an arrangement mode of cards of the operating player arranged on the play field 130 changes (when the deployment information changes), control to issue a notification for a specific operation instruction for the change using the display unit 210 or the sound output unit 220, under the control by the control unit 201. The change in the arrangement mode includes: flipping the relevant character card 110 of the operating player on the play field 130 to face up, or moving the relevant character card 110 to the discard portion 133. When an end condition of the game is satisfied as a result of the resolution, the control unit 201 makes the presentation control unit 207 present information related to the end of the match game, and the game processing is terminated.

In S709, the control unit 201 determines whether the operation input for ending the action turn has been made. When the control unit 201 determines that the operation input for ending the action turn has been made, the processing proceeds to S710. Otherwise, the processing returns to S706.

In S710, the control unit 201 ends the action turn of the operating player so that the opponent player starts his or her turn, and the processing returns to S703. In this process, the control unit 201 transmits the information of making the opponent player start the action turn to the communication unit 209 so that the information is shared with the smartphone 200 of the opponent.

On the other hand, when it is determined that the opponent player is in his or her action turn, the presentation control unit 207 issues a notification indicating that the opponent player is in his or her action turn under the control by the control unit 201 in S711.

In S712, upon receiving the deployment information on the opponent player (information on characters of the opponent player on each stage) from the smartphone 200 of the opponent, the control unit 201 stores the information in the memory 203.

In S713, the control unit 201 determines whether information on a result of resolving an action made by the opponent player has been received from the smartphone 200 of the opponent. When the control unit 201 determines that the information on the resolution result has been received, the processing proceeds to S714. Otherwise, the processing proceeds to S716.

In S714, the control unit 201 updates the corresponding information (such as, for example, the deployment information, information on acquisition of a treasure, and information on the accumulation action points for any of the players), based on the information on the resolution result received from the smartphone 200 of the opponent.

When the arrangement mode of the cards of the operating player arranged on the play field 130 changes due to the update based on the information on the resolution result (when the deployment information changes), in S715 the presentation control unit 207 performs control to issue a notification indicating the specific operation instruction for the specific change using the display unit 210 or the sound output unit 220, under the control by the control unit 201. When the end condition of the game is satisfied as a result of the resolution, the control unit 201 may make the presentation control unit 207 present information related to the end of the match game, and the game processing may be terminated.

In S716, the control unit 201 determines whether the action turn ends. The determination in this step is made in accordance with whether information indicating transition to the operating player's action turn has been received from the smartphone 200 of the opponent player. When the control unit 201 determines that the action turn ends, the processing proceeds to S717. Otherwise, the processing returns to S713.

In S717, the control unit 201 ends the opponents player's action turn to make the operating player start his or her action turn, and the processing returns to S703.

In this manner, in the game system of the present embodiment, the game processing is executed by the smartphones 200 used by the players in communicative connection, so that the action can be electrically resolved with a change in the arrangement status of cards on each play field 130 reflected, and each player can easily recognize the result of the resolution. The action can be made with the card placed face down on the field so that the opponent player cannot see the content of it, whereby a match game offering more tactical and entertaining gameplay can be provided.

In the game system of the present embodiment described above, the information acquired from the character card 110 and the stage card 120 stacked to be placed on one arrangement portion 131 is transmitted by the transmission unit 143 of the figure 140 to the smartphone 200 of the player in his or her action turn as the arrangement information. Then, the deployment information on the operating player updated based on the arrangement information is transmitted to the smartphone 200 of the opponent player. However, modes of the present invention are not limited to this. For example, the arrangement information may be transmitted to the smartphones 200 of both players, and each of the smartphones 200 may update the corresponding deployment information.

In the present embodiment described, the information provided to a card arranged on the play field 130 is acquired by the figure 140 brought close to or in contact with the card. However, modes of the present invention are not limited to this. For example, an image capturing device such as a camera of the smartphone 200 may be used to acquire the information provided to a card arranged on the play field 130. Furthermore, when players in the match game are in remote locations, a group of cards arranged on the play field 130 other than that in the deck may face up, so that the image capturing device can detect a movement of each card.

In the present embodiment, an instruction to change the orientation or the position of a card is presented as an operation instruction for changing the arrangement mode of the card. However, modes of the present invention are not limited to this, and may include other change instructions.

In the present embodiment described, the play field 130 is provided for each player. However, modes of the present invention are not limited to this. The play field 130 common to all the players in the match game may be provided, with the owner of a cards on the board being identifiable in a region.

In the mode described in the present embodiment, the stage card 120 is placed on the arrangement portion 131 of the play field 130 and the character card 110 is placed on the stage card 120, so that the position where the character card 110 (in association with which of the stage card 120) is arranged can be recognized when the information is acquired. However, modes of the present invention are not limited to this. For example, each of the arrangement portions 131 of the play field 130 may be provided with information identifying the arrangement portion 131. Then, when information on the character card 110 arranged is acquired, the identification information of the arrangement portion 131 is acquired, so that the position on the play field 130 where the character card 110 is arranged can be recognized. In other words, with the position of the play field 130 where the character card 110 is arranged being thus recognizable, a mode of the present invention can be implemented without requiring the stage card 120 to be arranged. In this case, the match application may allocate each arrangement portion 131 with a stage, and clearly indicate the stage allocated to each arrangement portion 131.

### Modification

In the embodiment described above, the arrangement of the character card 110 drawn from the deck to the arrangement portion 131 is not limited. However, modes of the present invention are not limited to this. For example, there may be a rule stipulating that a newly drawn character card 110 can be overlaid on the character card 110 that is currently arranged in the arrangement portion 131 only when these cards are of the same type, that is, when these cards are the same or has the common attribute information 803 for example.

### Other Embodiments

The present invention is not limited to the above-described embodiments, and various changes and modifications can be made within the scope of the invention without departing from the spirit and scope of the present invention. The information communication terminal of the game system according to the present invention can also be implemented with a program that causes one or more computers to function as the information communication terminal. The program can be provided/distributed by being recorded on a computer-readable storage medium or through telecommunication lines.

### REFERENCE SIGNS LIST

100 game toy
110 character card
120 stage card
130 play field
131 arrangement portion
132 deck portion
133 discard portion
140 figure
141 pedestal portion
142 reader
143 transmission unit
200 smartphone
201 control unit
202 storage medium
203 memory
204 character DB
205 stage DB
206 resolving unit
207 presentation control unit
208 operation input unit
209 communication unit
210 display unit
220 sound output unit

1. A game system implementing a match game played by players, the game system comprising, for each of the players:
a game toy; and
a communication terminal, wherein
the match game progresses through communication between the communication terminals of the players,
the game toy comprises:
a game item comprising game element information;
a play field on which the game item is capable of being arranged; and
an acquisition item that is capable of acquiring the game element information of the game item, and capable of transmitting the acquired game element information to the communication terminal, and
the communication terminal comprises:
a receiver that is capable of receiving an action instruction related to the match game, for the game item arranged on the play field of one of the players;
a resolving unit that is capable of resolving an action based on the action instruction received by the receiver; and
a notification unit that issues a notification of an operation instruction for the game item arranged on the play field based on a result of the resolution by the resolving unit.

2. The game system according to claim 1, wherein the communication terminal further comprises a presentation unit that is capable of presenting information on the game item arranged on the play field, based on the game element information received by the acquisition unit.

3. The game system according to claim 2, wherein the information on the game item presented by the presentation unit of the communication terminal of one of the players comprises information not presented by the presentation unit of the communication terminal used by an opponent player.

4. The game system according to claim 1, wherein the action instruction received by the receiver comprises an attack instruction for the game item arranged on the play field related to the opponent player.

5. The game system according to claim 4, wherein
the game item comprises:
a first game item provided with first game element information; and
a second game item provided with second game element information different from the first game element information,
the first game item is arranged on the play field in association with the second game item, and is able to be a target of the action instruction, and
the attack instruction for the first game item is accepted when the second game item associated with the second game element information that is the same as or of a same type as the second game item associated with the first game item, is arranged on the play field related to the opponent player, and the first game item is arranged in association with the second game item.

6. The game system according to claim 1, wherein
the match game is a match game in which the players alternately take turns to have an action turn during which the action instruction can be accepted, and
the receiver of the communication terminal used by one of the players is capable of accepting the action instruction for the game item only when the player is in his or her action turn.

7. The game system according to claim 6, wherein the game item related to one of the players is able to be newly arranged on the play field or to be moved in the play field while the player is in his or her turn.

8. The game system according to claim 1, wherein the operation instruction for the game item comprises an instruction to change an orientation of the game item arranged on the play field.

9. The game system according to claim 1, wherein the operation instruction for the game item comprises an instruction to change a position of the game item arranged on the play field.

10. A game toy used in the game system according to claim 1, the game toy comprising:
a first game item provided with first game element information;
a second game item provided with second game element information different from the first game element information;
the acquisition item capable of acquiring information from the first game item and the second game item; and
the play field in which an arrangement portion where the first game item and the second game item are arranged is visibly provided, wherein
the first game item used by each of the players and the second game item are able to be in an overlapped state to be arranged on the play field, and
the acquisition item comprises:
an acquisition unit that acquires information from the first game item and the second game item in the overlapped state; and
a transmission unit that transmits at least any one of the first game element information and the second game element information acquired by the acquisition unit to the communication terminal used by a corresponding one of the players.

11. The game toy according to claim 10, wherein the first game item is arrangeable on the second game item arranged on the play field.

12. The game toy according to claim 11, wherein the second game item on which the first game item is arranged is at least partially visible.

13. The game toy according to claim 11, wherein the first game item is able to be arranged on the first game item currently arranged on the play field, when the first game items are provided with the same or a same type of the first game element information.

14. The game toy according to claim 10, wherein the acquisition unit acquires information on at least one of the first game item and the second game item when placed close to or in contact with the at least one of the first game item and the second game item.

15. The game toy according to claim 10, wherein the first game item and the second game item are card members, and the acquisition item is a three-dimensional modeled object.

16. The game toy according to claim 10, wherein the play field comprises one play field provided for each of the players playing the match game.

17. A program control apparatus, comprising at least one processor and at least one non-volatile computer readable medium comprising computer code, the at least one non-volatile memory and the computer code configured to, with the processor, cause a computer to implement a match game played by players using a game toy comprising a game item provided with game element information and a play field on which the game item is able to be arranged, causing the computer to:
acquire information on the game item arranged on the play field;
receive an action instruction related to the match game, for the game item arranged on the play field related to a corresponding one of the players;
resolve an action based on the action instruction received; and
issue a notification of an operation instruction for the game item arranged on the play field based on a result of the resolution.
